(19) United States
(12) Patent Application Publication
(10) Pub. No.: US 2003/0089160 A1
(43) Pub. Date: May 15, 2003

(54) Exhaust gas sensor

(76) Inventor: Helmut Weyl, Schwieberdingen (DE)

Correspondence Address: KENYON & KENYON, ONE BROADWAY, NEW YORK, NY, 10004, US

(21) Appl. No.: 10/181,313

(22) PCT Filed: Nov. 13, 2001
(86) PCT No.: PCT/DE01/04225

(30) Foreign Application Priority Data
Nov. 14, 2000 (DE) 101 56 357.0

(51) Int. Cl. G01N 9/00

(52) U.S. Cl. 73/31.05

(57) ABSTRACT

A gas sensor, for example, a gas sensor for detecting at least one gas component in an exhaust gas is provided, in which a sensor element is situated in a metal housing. At a connection-side end of the housing, in a contact area, the sensor element has a support element, in which at least one partial area of at least one contact is situated. A porous material is situated between the support element and the housing. In the contact area, the housing includes at least one aperture. A flow path is situated along an outer surface of the support element, so that the exhaust gas, which may be located outside the gas sensor, may reach a connection-side end of the sensor element through the aperture in the housing, through the porous material and via the flow path along the outer surface of the support element.

### BACKGROUND INFORMATION

The present invention is based on a gas sensor according to the definition of the species in the main claims.

Gas sensors of a similar kind are described for example in German Patent Application 195 42 650 A1 and are used for example in the analysis of exhaust gases of internal combustion engines. A gas sensor of this generic type has a sensor element situated in a housing, having contact surfaces on its connection-side end. The contact surfaces are electrically connected with contact parts. A connecting element is provided for this purpose which is acted upon by a spring element, so that the connecting element presses the contact parts against the contact surfaces and an electrical contact is produced. The contact parts have crimp contacts, each of which is electrically connected with a connecting cable which leads out of the housing. The connecting cables are combined into a connecting line.

The sensor element situated in the housing works with a reference gas which is able to enter a reference gas chamber in the measurement area of the sensor element through an aperture provided on the connection-side end of the sensor element and through a reference gas channel which is made in the sensor element. Conducting the reference gas via the connecting line to the connection-side end of the sensor element is known from German Patent Application 196 11 572 A1. Gas-permeable sections are provided in the connecting line for this purpose.

A disadvantage of the related art is that severe demands must be made on the cleanliness of the components during production. Furthermore breathability, that is, the gas flow between the gas atmospheres outside and inside the housing, is limited, which may cause unwanted fluctuations in the concentration of a gas component in the reference gas chamber. This can cause the measurement result of the gas sensor to be corrupted.

### ADVANTAGES OF THE INVENTION

The gas sensor according to the present invention having the characterizing features of the main claims has the advantage over the related art that the gas sensor may be manufactured simply and efficiently and exhibits a satisfactory flow of a reference gas to a connection-side end of the sensor element, so that corruptions of the measurement result of the gas sensor due to too low or too high a concentration of at least one gas element in the reference gas are avoided.

For this purpose a support element is provided in a contact area in a connection-side area of the housing of the gas sensor. A porous material is situated between the support element and the housing. A flow path is provided along the outer surface of the support element. A reference gas located outside of the gas sensor is able to reach the connection-side end of the sensor element secured in the gas sensor through at least one aperture in the housing, through the porous material and via the flow path along the outer surface of the support element. The porous material prevents impurities from penetrating into the housing.

Alternatively, an aperture is provided in the support element through which the reference gas is able to reach the connection-side end of the sensor element via a recess in the carrier element which receives an end area of a connecting cable and a crimp joint of a contact part which is in contact with this connecting cable.

Advantageous refinements of the gas sensor described in the first main claim are possible with the measures indicated in the subordinate claims.

The flow path along the outer surface of the support element is formed by a taper of the support element on its side facing the sensor element and/or by an enlargement of the elements surrounding the support element. A taper or enlargement of this sort must be designed in such a way that a sufficient access of the reference gas outside the gas sensor to an interior space of the gas sensor is ensured, the connection-side end of the sensor element being situated in the interior space. For this purpose the taper or expansion may be stepped or conical in shape, for example. The taper of the support element may run around the entire surface area. It is also conceivable for the taper to be in the form of at least one channel-shaped recess in the surface of the support element, which connects the area outside the gas sensor with an interior space of the gas sensor. In a similar way, a channel-shaped enlargement of the elements surrounding the support element may be provided.

In a particularly advantageous embodiment of the present invention, the porous material is a porous sleeve made of a high-temperature-resistant plastic, which exhibits sufficient strength even at high temperatures and securely holds the support element.

In another particularly advantageous embodiment of the present invention the porous material is a porous hose, made for example of PTFE, which is stretched over a metallic inner sleeve so that the porous hose is situated between the metallic inner sleeve and the housing. The support element is securely held by the metallic inner sleeve. At least one aperture is also made in the metallic inner sleeve to ensure the exchange of gas. In the area of the taper and/or enlargement the support element has a clearance from the inner sleeve, so that the reference gas may pass between the support element and inner sleeve and reach the connection-side end of the sensor element. The taper of the support element and/or the enlargement of the metallic inner sleeve therefore extends beginning from the area of the aperture in the metallic inner sleeve in the direction of the sensor element.

In an advantageous embodiment of the present invention, at least one aperture is made in the support element, leading to a recess in the support element in which a crimp joint of the contact is situated. The reference gas is thus also able to reach the connection-side end of the sensor element through the aperture in the support element and the recess in the support element.

Advantageously, at least two of the apertures made in the housing, the metallic inner sleeve and the support element are positioned one above the other.

### DRAWINGS

Exemplary embodiments of the present invention are illustrated in the drawing and explained in the following description.

FIG. 1 shows a sectional view of a gas sensor according to the related art,

FIGS. 2, 3 and 4 show sectional views of a partial area of a first, second, and third version of a first exemplary embodiment of the gas sensor according to the present invention,

FIG. 5 shows a sectional view of a second embodiment of the gas sensor according to the present invention, and

FIG. 6 shows a cross section though the second embodiment corresponding to line VI-VI in FIG. 5.

### DESCRIPTION OF THE EXEMPLARY EMBODIMENTS

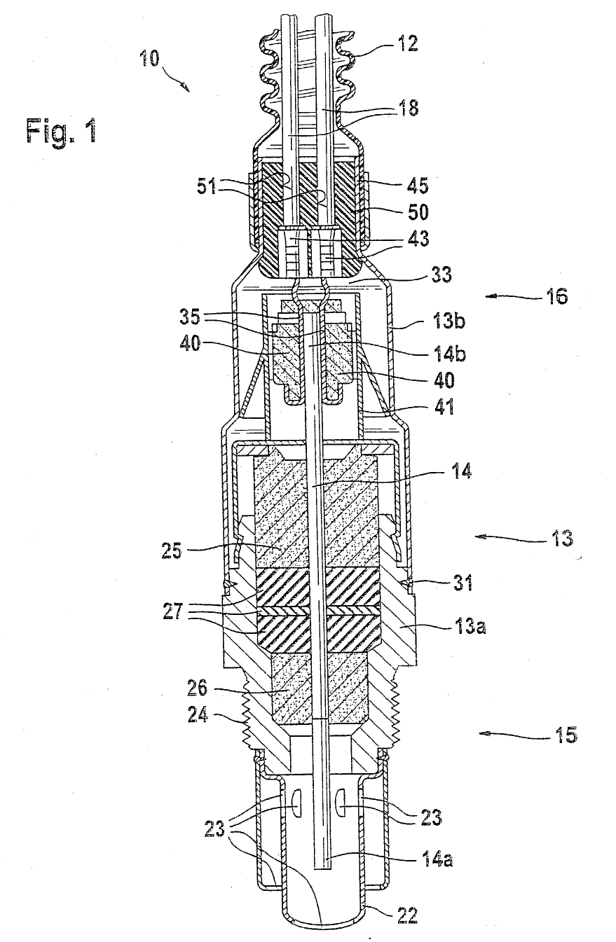

FIG. 1 shows a gas sensor 10, belonging for example to a lambda probe or a broadband lambda probe, according to the related art. Gas sensor 10 has a measurement-side section 15 and a connection-side section 16, and has a metal housing 13 whose measurement-side section is identified with the reference symbol 13a and whose connection-side section 16 is identified with the reference symbol 13b. In housing 13 a sensor element 14 is secured in a gas-tight manner using molded ceramic parts 25, 26 as well as a sealing element 27. Gas sensor 10 is connected in its connection-side section 16 with a cable jacket 12, which accommodates connecting cables 18 for sensor element 14.

On measurement-side section 13a of housing 13 a protective tube 22 having gas inlet and gas outlet apertures 23 is secured. Protective tube 22 surrounds measurement-side end 14a of sensor element 14, which protrudes from measurement-side section 13a of housing 13. Thread 24 is also applied to measurement-side section 15, whereby gas sensor 10 may be secured in an exhaust gas tube (not shown).

The connection-side section of housing 13b is secured in a gas-tight manner on the measurement-side section of housing 13a, using a radially encircling welded seam 31. The connection-side section of housing 13b surrounds connection-side end 14b of sensor element 14 and forms an interior space 33 containing a reference gas atmosphere, for example air, which is able to enter a reference gas channel (not shown) which is made in sensor element 14.

On connection-side end 14b, sensor element 14 has contact surfaces (not shown), which are in contact with contact parts 35. Contact parts 35 are located in a connecting element 40, having for example two parts, with the two parts of connecting element 40 held together by a spring element 41. Contact parts 35 are thereby pressed against the contact surfaces of sensor element 14. The cable-side section of contact parts 35 is designed with a crimp joint 43. Contact parts 35 are electrically connected with connection cables 18 by crimp joints 43.

Housing 13 has a tapering cylindrical section 45 on its connection-side end 13b. Cylindrical section 45 is closed with a cable feedthrough 50. Cable feedthrough 50 is made of PTFE, for example, and has through holes 51 corresponding to the number of connecting cables 18 to be fed through. Through holes 51 are designed with a diameter such that a gap is formed between connecting cable 18 and through holes 51, through which the reference gas may enter into interior space 33. Cable sleeve 12 is for example a PTFE hose, having pores and/or gas-permeable sections on its surface through which the reference air is able to penetrate into the interior of the hose.

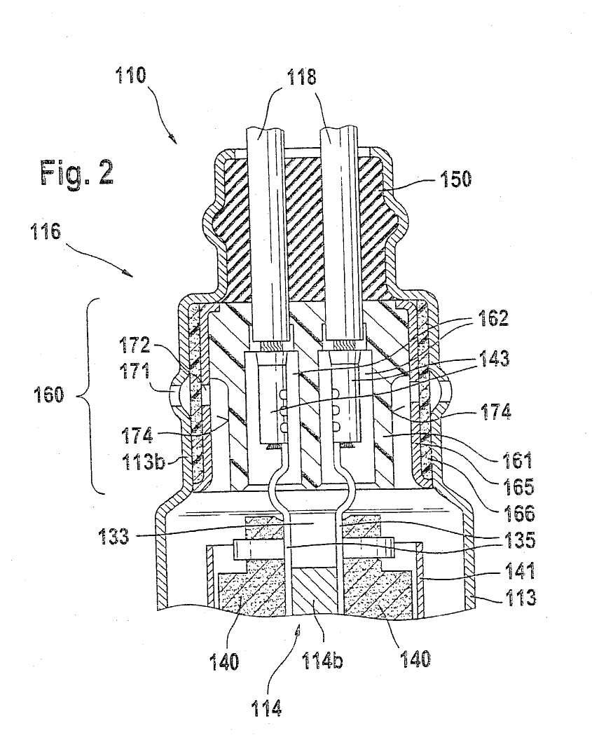

FIG. 2 shows a connection-side section 116 of a first version of a first exemplary embodiment of a gas sensor 110 according to the present invention. The figure shows connection-side section 113b of a metal housing 113 in which a connection-side end 114b of a sensor element 114 having contact surfaces (not shown) is positioned. The contact surfaces of sensor element 114 are electrically connected with contact parts 135, which are pressed against the contact surfaces of the sensor element by a spring element 141 which acts on a connecting element 140. Contact parts 135 have crimp joints 143 in a contact area 160, which produce an electrical contact of contact parts 135 to connecting cables 118 which lead out of housing 113. Connecting cables 118 are sealed in a gas-tight manner by a cable feedthrough 150. Cable feedthrough 150 may be made for example of a silicon rubber or of a temperature-resistant fluoroelastomer, for example Viton (fluorocarbon rubber) (FKM) from the Dupont Company.

In contact area 160, a support element 161 is provided. Support element 161 has recesses 162 to receive connecting cables 118 and crimp joints 143 of contact parts 135. Recesses 162 become narrower on the side toward connecting cables 118, preventing connecting cables 118 from sliding out of support element 161. Contact parts 135 protrude from the end of support element 161 facing sensor element 114, into an interior space 133 of housing 113. On connection side 114b in interior space 133 of connection-side section 113b of housing 113, sensor element 114 has an aperture (not shown) of a reference gas chamber located in the sensor element.

Incorporated into housing 113 is a metallic inner sleeve 165 which surrounds support element 161. Between inner sleeve 165 and housing 113 there is a porous hose in contact area 160. Porous hose 166 is made of PTFE; support element 161 is made of solid PTFE or a high-temperature-resistant plastic such as polyimide, polyether ketone (PEK) or polyether ether ketone (PEEK).

Apertures 171 are made in housing 113 and apertures 172 in inner sleeve 165. Openings 171, 172 of housing 113 and inner sleeve 165 are positioned one above the other. That enables the reference gas to enter through apertures 171 of housing 113, through porous hose 166 and apertures 172 of inner sleeve 165 into the area of support element 161.

On its side facing sensor element 114 support element 161 has a taper 174, which extends beginning from the area of apertures 171, 172 of housing 113 and of inner sleeve 165 in the direction of sensor element 114. In the area of taper 174, support element 161 is positioned at a clearance from inner sleeve 165. Through the space between support element 161 in the area of taper 174 and inner sleeve 165 the reference gas is able to reach connection-side end 114b of sensor element 114 and thus the reference gas chamber. The taper extends on the side facing sensor element 114 over the entire surface of support element 161.

In an alternative embodiment (not shown), it is possible to provide for the taper to lead as a channel from the aperture in the inner sleeve and/or in the housing to the interior space. A plurality of channel-like tapers may be provided, corresponding to the number of apertures. Outside of the channel-like tapers, the support element rests directly against the inner sleeve, so that the support element is secured additionally on its side facing the sensor element.

In another alternative embodiment (not shown), the apertures of the housing and of the inner sleeve are rotated with respect to each other. In this case it is necessary to be sure that sufficient exchange of gas is ensured between the aperture of the housing and the aperture of the inner sleeve through the porous hose placed between housing and inner sleeve.

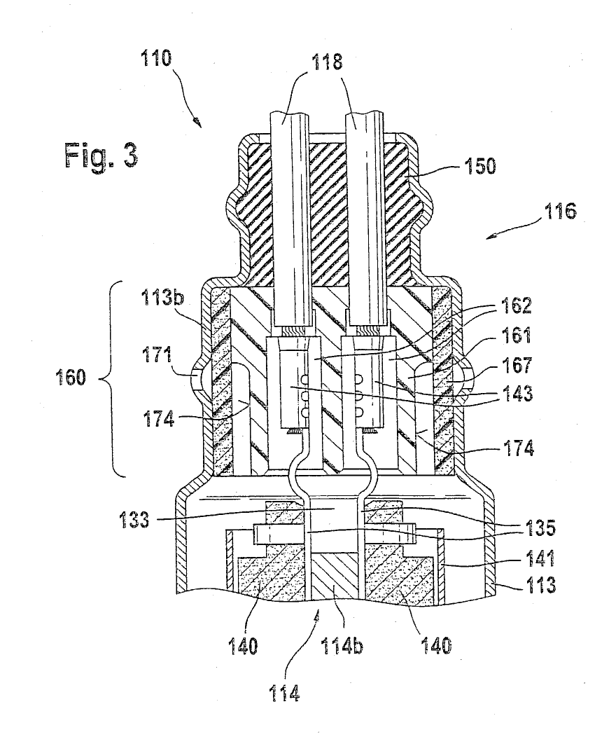

FIG. 3 shows a second version of the first embodiment, which differs from the first version shown in FIG. 2 in that between housing 113 and support element 161, instead of inner sleeve 165 and porous hose 166 a porous sleeve 167 having a porous material is provided. Porous sleeve 167 is made of PTFE, for example. The reference gas is able to pass through aperture 171 made in housing 113, porous sleeve 167 and via the space between taper 174 of support element 161 and porous sleeve 167 into interior space 133 and thus to the reference gas chamber of sensor element 114.

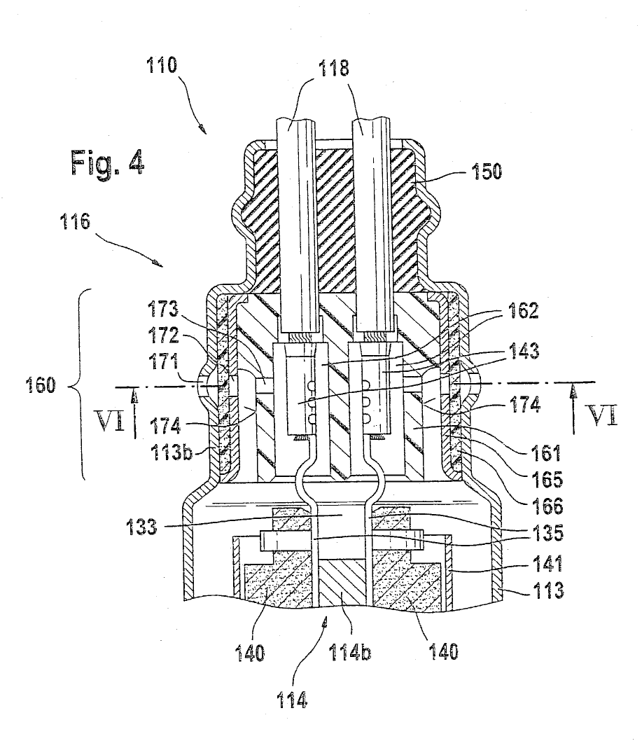

FIG. 4 shows a third version of the first embodiment, which differs from the first and second versions in that support element 161 has at least one aperture 173, which is situated in the area of aperture 172 of inner sleeve 165 and leads to recess 162 in support element 161. The reference gas is thus able to pass both via the area of taper 174 of support element 161 and through aperture 173 and recess 162 of support element 161 to interior space 133. Four apertures 173 are provided in support element 161, corresponding to the number of recesses 162. Accordingly, there are also four apertures 172 made in inner sleeve 165.

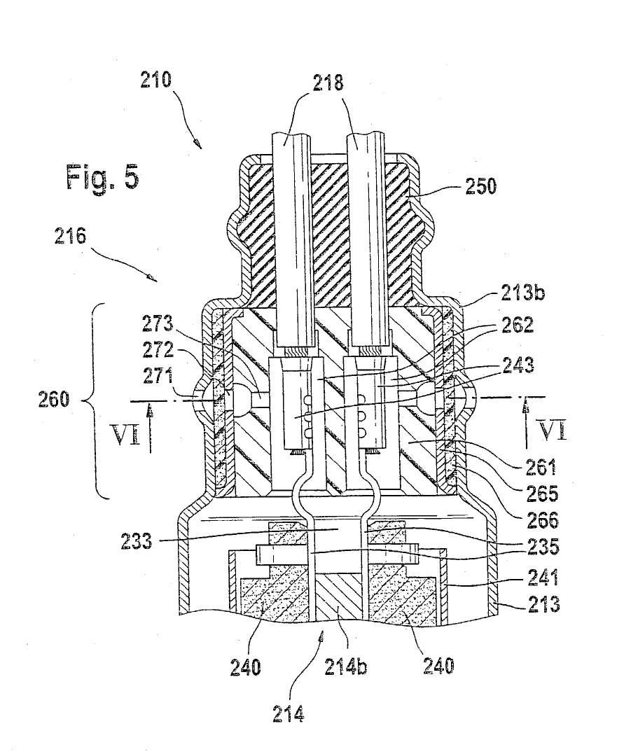

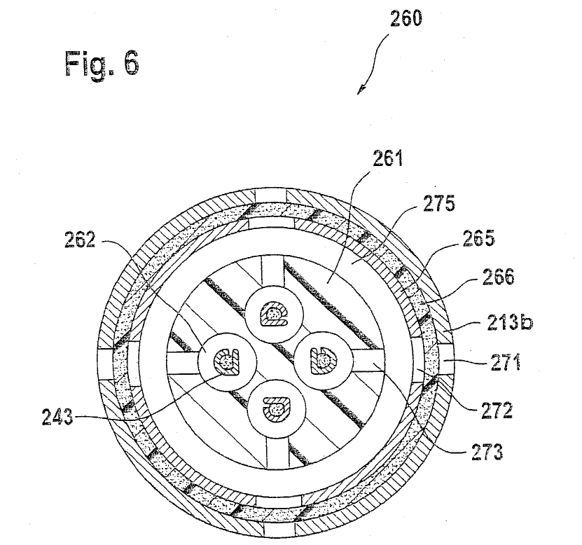

FIG. 5 and FIG. 6 show a connection-side section 216 of a second embodiment of a gas sensor according to the present invention. Connection-side section 213b of a metal housing 213 is shown, in which a connection-side end 214b of a sensor element 214 with contact surfaces (not shown) is situated. The contact surfaces of sensor element 214 are electrically connected with contact parts 235, which are pressed against the contact surfaces of sensor element 214 by a spring element 241 which acts on a connecting element 240. Contact parts 235 have crimp joints 243 in a contact area 260, which produce an electrical contact of contact parts 235 to connecting cables 218 which lead from sensor element 214. Connecting cables 218 are sealed gas-tight by a cable feedthrough 250. Cable feedthrough 250 may be made for example of a silicon rubber or of a temperature-resistant fluoroelastomer, for example Viton (fluorocarbon rubber) from the Dupont Company.

A support element 261 is provided in contact area 260. Support element 261 has recesses 262 to receive connecting cables 218 and crimp joints 243 of contact parts 235. Recesses 262 become narrower on the side toward connecting cables 218, preventing connecting cables 218 from sliding out of support element 261. Contact parts 235 protrude from the end of support element 261 facing sensor element 214, into an interior space 233 of housing 213.

Support element 261 is surrounded by a metallic inner sleeve 265. Between inner sleeve 265 and housing 213 there is a porous material in contact area 260. The porous material is for example a porous hose 266. Porous hose 266 is made for example of PTFE, support element 261 is likewise made for example of solid PTFE or a high-temperature-resistant plastic such as polyimide, polyether ketone (PEK) or polyether ether ketone (PEEK).

Sensor element 214 has on its connection side an aperture (not shown) to a reference gas chamber situated in the sensor element. The aperture faces interior space 233 of housing 213. In order to enable access for the reference gas which is outside of connection-side section 216 of the gas sensor to interior space 233 and thus to the reference gas chamber, apertures 271 are made in housing 213, apertures 272 in inner sleeve 265, and apertures 273 in support element 261. Apertures 273 in support element 261 lead to recesses 262.

Apertures 271, 272, 273 are positioned one above the other in housing 213b, inner sleeve 265 and support element 261, which enables the reference gas to pass through apertures 271 in housing 213b, porous hose 266, apertures 272 in inner sleeve 165, apertures 273 in support element 261, and recesses 262, in interior space 233 and thus to the-reference gas chamber of sensor element 214.

In an alternative version—not shown—of the second embodiment, instead of the inner sleeve and the porous hose, a porous sleeve having a porous material is provided between the housing and the support element. The porous sleeve is made for example of PTFE.

What is claimed is:

1. A gas sensor, in particular for detecting at least one gas component in an exhaust gas, having a sensor element (114) situated in a housing (113), a support element (161) being provided at a connection-side end (113b) of the housing (113), in a contact area (160), wherein a porous material (166, 167) is provided between the support element (161) and the housing (113), at least one aperture (171) is made in the housing (113), in the contact area (160), and a flow path is provided along an outer surface of the support element (161).

2. The gas sensor according to claim 1, wherein a reference gas located outside the gas sensor (110) is able to reach a connection-side end (114b) of the sensor element (114) through the aperture (171) of the housing (113), through the porous material (166, 167), and via the flow path along the outer surface of the support element (161).

3. The gas sensor according to claim 1 or 2, wherein the flow path is formed by a taper (174) of the support element (161) on its area facing the sensor element (114).

4. The gas sensor according to one of the preceding claims, wherein the flow path is formed by an enlargement of the elements (113, 165, 166, 167) surrounding the support element (161).

5. The gas sensor according to one of the preceding claims, wherein a reference gas channel is introduced in the sensor element (114), the reference gas channel having an aperture at the connection-side end (114b) of the sensor element (114), through which the reference gas is able to enter into a reference gas chamber.

6. The gas sensor according to one of the preceding claims, wherein the connection-side end (114b) of the sensor element (114) has at least one contact surface, which makes electrical contact with a contact part (135) due to the contact part (135) being pressed against the contact surface by a spring element (141) acting on a connecting element (140).

7. The gas sensor according to claim 6, wherein the contact part (135) has a crimp joint (143) by which the contact part (135) is electrocondactively connected to the connecting cable (118).

8. The gas sensor according to claim 7, wherein the support element (161) includes at least one partial area of at least one contact, while the support element (161) has at least one recess (162) for receiving the end area of at least one connecting cable (118) and the crimp joint (143) of the contact part (135), which is in contact with this connecting cable (118).

9. The gas sensor according to at least one of the preceding claims, wherein the support element (161) has at least one aperture (173) which leads to a recess (162) of the support element (161).

10. The gas sensor according to claim 9, wherein at least one aperture (171) introduced into the housing (113) and at least one aperture (173) introduced into the support element (161) are positioned one above the other.

11. The gas sensor according to at least one of the preceding claims, wherein the aperture (173) is radially introduced into in the support element (161).

12. The gas sensor according to at least one of the preceding claims, wherein the connecting cable (118) is lead through a recess made in the housing (113), out of the housing (113), a cable feedthrough (150) being provided in the area of the recess of the housing (113) to provide a gas-tight seal and to hold the connecting cable (118).

13. The gas sensor according to claim 12, wherein the cable feedthrough (150) contains silicon rubber or a fluoroelastomer.

14. The gas sensor according to at least one of the preceding claims, wherein the support element (161) contains PTFE and/or a plastic resistant to high temperatures, in particular polyimide, polyether ketone (PEK) or polyether ether ketone (PEEK).

15. The gas sensor according to at least one of the preceding claims, wherein the porous material is a porous hose (166), and a metallic inner sleeve (165) into which at least one aperture (172) is introduced is provided between the porous hose (166) and the support element (161).

16. The gas sensor according to claim 15, wherein the porous hose (166) contains PTFE.

17. The gas sensor according to claim 15 or 16, wherein at least one aperture (171) introduced into the housing (113) and at least one aperture (172) introduced into the inner sleeve (165) are positioned one above the other.

18. The gas sensor according to claims 15 through 17, wherein at least one aperture (172) introduced into the inner sleeve (165) and at least one aperture (173) introduced into the support element (161) are positioned one above the other.

19. The gas sensor according to claims 15 through 18, wherein the hollow cylindrical inner sleeve (165) has approximately the same height as the cylindrical support element (161).

20. The gas sensor according to at least one of claims 1 through 14, wherein the porous material is a porous sleeve (167).

21. The gas sensor according to claim 20, wherein the porous sleeve (167) contains PTFE.

22. A gas sensor, in particular for detecting at least one gas component in an exhaust gas, having a sensor element (214) situated in a housing (213), a support element (261) including at least one partial area of at least one contact being provided at a connection-side end (213b) of the housing (213) in a contact area (260), wherein a porous material (266, 267) is provided between the support element (261) and the housing (213b), at least one aperture (271, 273) is introduced into the housing (213b) and the support element (261), respectively, the support element (261) has at least one recess (262) for receiving the end area of at least one connecting cable (218) and a crimp joint (243) of a contact part (235), which is in contact with this connection cable (218), the aperture is radially introduced into the support element (261), and the connecting cable (218) is lead through a recess made in the housing (213), out of the housing (213), a cable feedthrough (250) being provided in the area of the recess of the housing (213) to provide a gas-tight seal and to hold the connecting cable (218).
